(19) United States
(12) Patent Application Publication
(10) Pub. No.: US 2009/0287877 A1
(43) Pub. Date: Nov. 19, 2009

(54) MULTI NON-VOLATILE MEMORY CHIP PACKAGED STORAGE SYSTEM AND CONTROLLER AND ACCESS METHOD THEREOF

(75) Inventors: Chien-Hua Chu, Hsinchu County (TW); Kuo-Yi Cheng, Taipei City (TW); Chih-Kang Yeh, Kinmen County (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/197,460

(22) Filed: Aug. 25, 2008

(30) Foreign Application Priority Data
May 15, 2008 (TW) 97117904

(51) Int. Cl. G06F 12/02

(52) U.S. Cl. 711/103; 711/E12.008

(57) ABSTRACT

A multi non-volatile memory chip packaged storage system having a memory module, a controller, a first and a second control buses and a first and a second I/O buses is provided. The memory module at least includes a first and a second non-volatile memory chips which are both enabled by receiving a chip enabled signal via a chip enabled pin, wherein the memory module and the controller are stacked and packaged as a single chip. After the first and the second non-volatile memory chips are enabled by the chip enable signal via the chip enabled pin, the controller may active the first and second control buses and the first and second I/O buses to access the first and the second non-volatile memory chips, or only active the first control and I/O buses or the second control and I/O buses to access the corresponding first or second non-volatile memory chip.

### CROSS-REFERENCE TO RELATED APPLICATION

This application claims the priority benefit of Taiwan application serial no. 97117904, filed on May 15, 2008. The entirety of the above-mentioned patent application is hereby incorporated by reference herein and made a part of this specification.

### BACKGROUND

1. Technology Field

The present invention relates to a storage system and a controller and an access method thereof. More particularly, the present invention relates to a multi non-volatile memory chip packaged storage system and a controller and an access method thereof, by which multi channel access of multi non-volatile memory chips and single channel access of a specific non-volatile memory chip can be executed in case of less chip enable pins.

2. Description of Related Art

With a quick development of digital camera, cell phone camera and MP3, demand of storage media by customers is increased greatly. Since a flash memory has the advantages of non-volatile, energy saving, small size and none mechanical structure etc., it is suitable for portable applications, and especially for portable battery-powered products. A memory card is storage device applying the flash memory. Since the memory card has a small sized and is easy to be carried around, it is widely used for storing important personal data. Therefore, the flash memory industry becomes a hot industry within the electronics industry recently.

To increasing a data accessing amount, a non-volatile memory module (for example, a flash memory module) of a general storage system is formed by stacking and packaging a plurality of memory chips, and the memory chips can be interleavely accessed, so that the data accessing amount within unit time is greater than that of an earlier memory module only packaged with a single memory chip.

FIG. 1 is a block diagram illustrating a flash memory storage system according to a conventional technique. A controller 140 of the flash memory storage system 100 can respectively enable a first flash memory chip 104, a second flash memory chip 106, a third flash memory chip 108, a fourth flash memory chip 110, a fifth flash memory chip 112, a sixth flash memory chip 114, a seventh flash memory chip 116 and an eighth flash memory chip 118 via a first chip enable pin CE0, a second chip enable pin CE1, a third chip enable pin CE2, a fourth chip enable pin CE3, a fifth chip enable pin CE4, a sixth chip enable pin CE5, a seventh chip enable pin CE6 and an eighth chip enable pin CE7. Moreover, due to a limitation that each control bus can only drive four flash memories, the flash memory storage system 100 may include a first control bus 120 used for executing control commands to the first flash memory chip 104, the second flash memory chip 106, the third flash memory chip 108 and the fourth flash memory chip 110, and a second control bus 122 used for executing control commands to the fifth flash memory chip 112, the sixth flash memory chip 114, the seventh flash memory chip 116 and the eighth flash memory chip 118. Similarly, due to a limitation that each I/O bus can only drive four flash memories, the flash memory storage system 100 may include a first I/O bus 124 used for executing commands and transmitting data to the first flash memory chip 104, the second flash memory chip 106, the third flash memory chip 108 and the fourth flash memory chip 110, and a second I/O bus 126 used for executing commands and transmitting data to the fifth flash memory chip 112, the sixth flash memory chip 114, the seventh flash memory chip 116 and the eighth flash memory chip 118.

In the flash memory storage system 100, when the controller 140 is desired to write data into the first flash memory chip 104, the controller 140 first enables the first flash memory chip 104 via the first chip enable pin CE0, and executes a write command to the first flash memory chip 104 via the first control bus 120 and the first I/O bus 124, and then data to be written is transmitted via the first I/O bus 124. When the controller 140 is desired to simultaneously write data into the first flash memory chip 104 and the fifth flash memory chip 112, the controller 140 first enables the first flash memory chip 104 via the first chip enable pin CE0, and enables the fifth flash memory chip 112 via the fifth chip enable pin CE4, and then respectively executing the write command to the first flash memory chip 104 and the fifth flash memory chip 112 via the first control bus 120 and the first I/O bus 124, and the second control bus 122 and the second I/O bus 126, and simultaneously transmits the data to be written via the first I./O bus 124 and the second I/O bus 126.

As described above, the conventional non-volatile memory storage system respectively enables a plurality of non-volatile memory chips via a plurality of chip enable pins, so as to perform a single channel access to a specific non-volatile memory chip, and the conventional non-volatile memory storage system may also simultaneously perform a double channel access to multi non-volatile memory chips via two I/O buses after respectively enables the non-volatile memory chips.

Though according to the conventional method, the single channel access and the double channel access of the non-volatile memory chip can be achieved, since a plurality of the chip enable pins is required for respectively enabling different non-volatile memory chips, a size of the non-volatile memory storage system is increased, which is of no avail to the portable memory cards requiring design features of lightness, slimness, shortness and smallness. Particularly, if the storage system is a system-on-chip, it is important to minimize the size of the storage system. Moreover, applying of multiple chip enable pins can also increase a cost of the non-volatile memory storage system.

### SUMMARY

Accordingly, the present invention is directed to a multi non-volatile memory chip packaged storage system, which may perform a multi channel access to multi non-volatile memory chips, and perform a single channel access to a single non-volatile memory chip in case of less chip enable pins.

The present invention is directed to a controller, which may execute accessing steps, so that a multi non-volatile memory chip packaged storage system may perform a multi channel access to multi non-volatile memory chips, and perform a single channel access to a single non-volatile memory chip in case of less chip enable pins.

The present invention is directed to a method, by which a multi non-volatile memory chip packaged storage system may perform a multi channel access to multi non-volatile memory chips, and perform a single channel access to a single non-volatile memory chip in case of less chip enable pins.

The present invention provides a multi non-volatile memory chip packaged storage system including a memory module, a controller, a first and a second input/output (I/O) buses and a first and a second control buses. The memory module at least includes a first non-volatile memory chip and a second non-volatile memory chip, which may be both enabled by simultaneously receiving a chip enable signal via a first chip enabled pin. The controller is electrically connected to the memory module and is used for outputting the chip enable signal, wherein the controller and the memory module are stacked and packaged as a single chip based on a multi-chip package (MCP) technique. The first I/O bus and the first control bus are electrically connected between the first non-volatile memory chip and the controller, and the second I/O bus and the second control bus are electrically connected between the second non-volatile memory chip and the controller. When the controller is desired to perform a multi channel access, after the controller enables the first non-volatile memory chip and the second non-volatile memory chip via the first chip enabled pin, the controller executes an accessing command to the first non-volatile memory chip via the first control bus and the first I/O bus, and transmits accessed data via the first I/O bus, and meanwhile executes the accessing command to the second non-volatile memory chip via the second control bus and the second I/O bus, and transmits accessed data via the second I/O bus. Moreover, when the controller performs a single channel access to the first non-volatile memory chip, after the controller enables the first non-volatile memory chip and the second non-volatile memory chip via the first chip enable pin, the controller only executes the accessing command to the first non-volatile memory chip via the first control bus and the first I/O bus, and transmits the accessed data via the first I/O bus. Moreover, when the controller performs the single channel access to the second non-volatile memory chip, after the controller enables the first non-volatile memory chip and the second non-volatile memory chip via the first chip enable pin, the controller only executes the accessing command to the second non-volatile memory chip via the second control bus and the second I/O bus, and transmits the accessed data via the second I/O bus.

In an embodiment of the present invention, the first control bus and the first I/O bus, and the second control bus and the second I/O bus are respectively electrically connected to the first non-volatile memory chip and the second non-volatile memory chip at two adjacent sides of the controller.

In an embodiment of the present invention, the accessing command includes a write command and a read command.

In an embodiment of the present invention, the memory module further includes a third, a fourth, a fifth, a sixth, a seventh and an eighth non-volatile memory chips. The third, the fifth and the seventh non-volatile memory chips are electrically connected to the first I/O bus and the first control bus, and the fourth, the sixth and the eighth non-volatile memory chips are electrically connected to the second I/O bus and the second control bus, wherein the controller enables the third and the fourth non-volatile memory chips via a second chip enable pin, enables the fifth and the sixth non-volatile memory chips via a third chip enable pin, and enables the seventh and the eighth non-volatile memory chips via a fourth chip enable pin.

In an embodiment of the present invention, the first non-volatile memory chip and the second non-volatile memory chip are single level cell (SLC) NAND flash memories or multi level cell (MLC) NAND flash memories.

In an embodiment of the present invention, the multi non-volatile memory chip packaged storage system further includes a data transmission link interface for connecting a host.

In an embodiment of the present invention, the data transmission link interface is a PCI express interface, a USB interface, an IEEE 1394 interface, a SATA interface, an MS interface, an MMC interface, an SD interface, a CF interface or an IDE interface.

The present invention provides a controller adapted to control a memory module of a multi non-volatile memory chip packaged storage system. The memory module includes at least a first non-volatile memory chip and a second non-volatile memory chip, which may both be enabled by simultaneously receiving a chip enable signal via a first chip enabled pin. The controller includes a memory interface and a microprocessor. The memory interface is used for accessing the memory module. The microprocessor is electrically connected to the memory interface and is used for outputting the chip enable signal. When the microprocessor performs a multi channel access, after the microprocessor enables the first non-volatile memory chip and the second non-volatile memory chip via the first chip enabled pin, the microprocessor executes an accessing command to the first non-volatile memory chip via the first control bus and the first I/O bus of the multi non-volatile memory chip packaged storage system, and transmits accessed data via the first I/O bus of the multi non-volatile memory chip packaged storage system, and meanwhile executes the accessing command to the second non-volatile memory chip via the second control bus and the second I/O bus of the multi non-volatile memory chip packaged storage system, and transmits accessed data via the second I/O bus of the multi non-volatile memory chip packaged storage system. Moreover, when the microprocessor performs a single channel access to the first non-volatile memory chip, after the microprocessor enables the first non-volatile memory chip and the second non-volatile memory chip via the first chip enable pin, the microprocessor only executes the accessing command to the first non-volatile memory chip via the first control bus and the first I/O bus, and transmits the accessed data via the first I/O bus. Moreover, when the microprocessor performs the single channel access to the second non-volatile memory chip, after the microprocessor enables the first non-volatile memory chip and the second non-volatile memory chip via the first chip enable pin, the microprocessor only executes the accessing command to the second non-volatile memory chip via the second control bus and the second I/O bus, and transmits the accessed data via the second I/O bus.

In an embodiment of the present invention, the accessing command includes a write command and a read command.

In an embodiment of the present invention, the memory module further includes a third, a fourth, a fifth, a sixth, a seventh and an eighth non-volatile memory chips. The third, the fifth and the seventh non-volatile memory chips are electrically connected to the first I/O bus and the first control bus, and the fourth, the sixth and the eighth non-volatile memory chips are electrically connected to the second I/O bus and the second control bus, wherein the controller enables the third and the fourth non-volatile memory chips via a second chip enable pin, enables the fifth and the sixth non-volatile memory chips via a third chip enable pin, and enables the seventh and the eighth non-volatile memory chips via a fourth chip enable pin.

In an embodiment of the present invention, the first non-volatile memory chip and the second non-volatile memory chip are single level cell (SLC) NAND flash memories or multi level cell (MLC) NAND flash memories.

In an embodiment of the present invention, the multi non-volatile memory chip packaged storage system includes a USB flash drive, a flash memory card and a solid state drive.

The present invention provides an access method adapted to access a memory module of a multi non-volatile memory chip packaged storage system. The memory module includes at least a first non-volatile memory chip and a second non-volatile memory chip, which may both be enabled by simultaneously receiving a chip enable signal via a same chip enabled pin. The method includes following steps. First, whether the first non-volatile memory chip and the second non-volatile memory chip are simultaneously accessed or only the first non-volatile memory chip or the second non-volatile memory chip is accessed is judged. Next, when it is judged that the first non-volatile memory chip and the second non-volatile memory chip are simultaneously accessed, the first non-volatile memory chip and the second non-volatile memory chip are enabled by a chip enable signal, and an accessing command is executed to the first non-volatile memory chip via a first control bus and a first I/O bus of the multi non-volatile memory chip packaged storage system, and the accessing command is executed to the second non-volatile memory chip via a second control bus and a second I/O bus of the multi non-volatile memory chip packaged storage system, and accessed data of the first non-volatile memory chip and the second non-volatile memory chip are respectively transmitted via the first I/O bus and the second I/O bus of the multi non-volatile memory chip packaged storage system. Moreover, when it is judged that only the first non-volatile memory chip is accessed, the first non-volatile memory chip and the second non-volatile memory chip are enabled by the chip enable signal, and the accessing command is only executed to the first non-volatile memory chip via the first control bus and the first I/O bus, and accessed data of the first non-volatile memory chip is transmitted via the first I/O bus. Moreover, when it is judged that only the second non-volatile memory chip is accessed, the first non-volatile memory chip and the second non-volatile memory chip are enabled by the chip enable signal, and the accessing command is only executed to the second non-volatile memory chip via the second control bus and the second I/O bus, and accessed data of the second non-volatile memory chip is transmitted via the second I/O bus.

In an embodiment of the present invention, the accessing command includes a write command and a read command.

In the present invention, a single chip enable pin is applied to connect multiple non-volatile memory chips based on the MCP technique, and different accessing commands are executed to different non-volatile memory chips via a plurality of the control and I/O buses. Therefore, the multi channel access and the single channel access can be achieved in case of less chip enable pins.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a flash memory storage system according to a conventional technique.

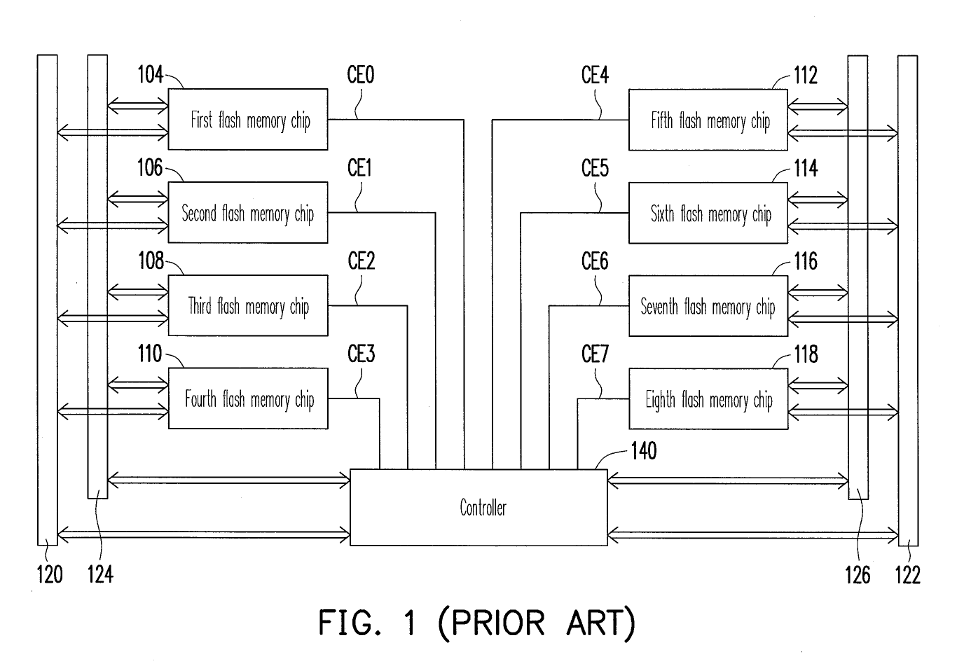

FIG. 2 is a block diagram illustrating a multi non-volatile memory chip packaged storage system according to an embodiment of the present invention.

FIG. 3 is a top view of a multi non-volatile memory chip packaged storage system according to an embodiment of the present invention.

FIG. 4 is a flowchart illustrating a data access method according to an embodiment of the present invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

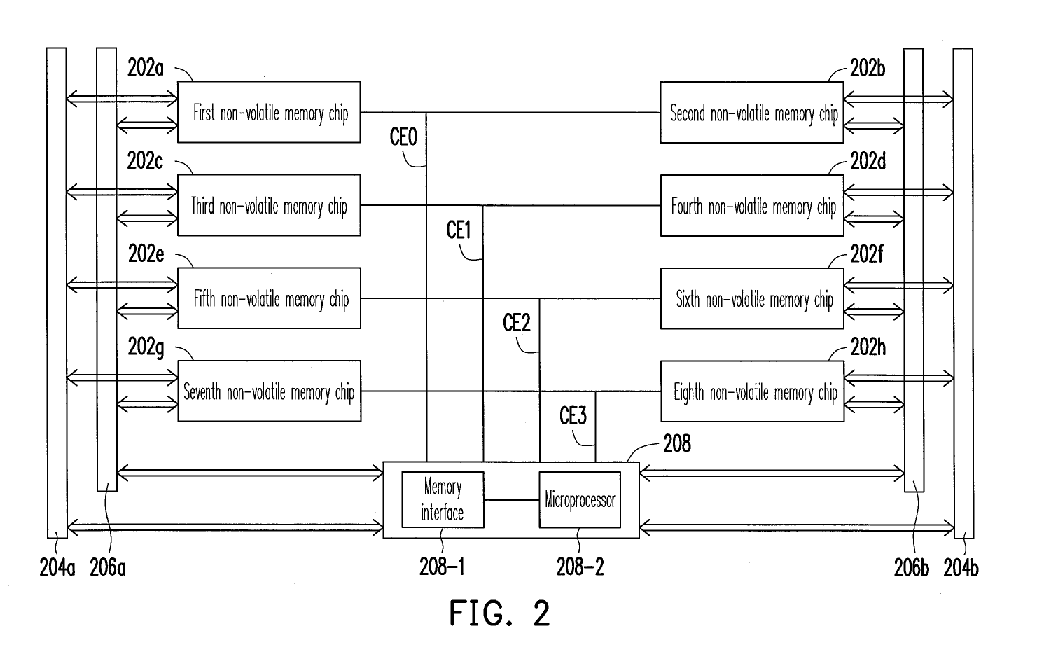

FIG. 2 is a block diagram illustrating a multi non-volatile memory chip packaged storage system according to an embodiment of the present invention.

Referring to FIG. 2, the multi non-volatile memory chip packaged storage system 200 is a system on chip packaged based on a multi-chip package (MCP) technique.

The multi non-volatile memory chip packaged storage system 200 includes a memory module comprising a first non-volatile memory chip 202a, a second non-volatile memory chip 202b, a third non-volatile memory chip 202c, a fourth non-volatile memory chip 202d, a fifth non-volatile memory chip 202e, a sixth non-volatile memory chip 202f, a seventh non-volatile memory chip 202g and an eighth non-volatile memory chip 202h, a first control bus 204a, a second control bus 204b, a first I/O bus 206a, a second I/O bus 206b and a controller 208.

The multi non-volatile memory chip packaged storage system 200 is generally utilized together with a host (not shown), so that the host can store data into the multi non-volatile memory chip packaged storage system 200 or read data from the multi non-volatile memory chip packaged storage system 200. In the present invention, the multi non-volatile memory chip packaged storage system 200 is a memory card. It should be noted that in another embodiment of the present invention, the multi non-volatile memory chip packaged storage system 200 can also be a flash drive or a solid state drive (SSD).

The first non-volatile memory chip 202a, the second non-volatile memory chip 202b, the third non-volatile memory chip 202c, the fourth non-volatile memory chip 202d, the fifth non-volatile memory chip 202e, the sixth non-volatile memory chip 202f, the seventh non-volatile memory chip 202g and the eighth non-volatile memory chip 202h are used for storing data. In the present embodiment, the first non-volatile memory chip 202a, the second non-volatile memory chip 202b, the third non-volatile memory chip 202c, the fourth non-volatile memory chip 202d, the fifth non-volatile memory chip 202e, the sixth non-volatile memory chip 202f, the seventh non-volatile memory chip 202g and the eighth non-volatile memory chip 202h are SLC NAND flash memory chips. However, the present invention is not limited thereto, and the non-volatile memory chips can also be MLC NAND flash memory chips or other suitable non-volatile memory chips.

Moreover, it should be noted that though the memory module having 8 non-volatile memory chips is taken as an example, the memory module having arbitrary number of non-volatile memory chips can also be applied.

The first control bus 204a and the second control bus 204b are used for respectively coordinating with the first I/O bus 206a and the second I/O bus 206b to execute commands sent from the controller 208 in accordance with a transmission protocol. The first control bus 204a is electrically connected between the first non-volatile memory chip 202a, the third non-volatile memory chip 202c, the fifth non-volatile memory chip 202e, the seventh non-volatile memory chip 202g and the controller 208. The second control bus 204b is electrically connected between the second non-volatile memory chip 202b, the fourth non-volatile memory chip 202d, the sixth non-volatile memory chip 202f, the eighth non-volatile memory chip 202h and the controller 208. In other words, when the controller 208 is desired to execute a control command to the first non-volatile memory chip 202a, the third non-volatile memory chip 202c, the fifth non-volatile memory chip 202e and the seventh non-volatile memory chip 202g, the first control bus 204a and the first I/O bus 206a are utilized to execute the control command, and when the controller 208 is desired to execute a control command to the second non-volatile memory chip 202b, the fourth non-volatile memory chip 202d, the sixth non-volatile memory chip 202f and the eighth non-volatile memory chip 202h, the second control bus 204b and the second I/O bus 206b are utilized to execute the control command. In the present embodiment, the first control bus 204a and the second control bus 204b respectively include a read enable (RE) pin, a write enable (WE) pin, a command latch enable (CLE) pin, an address latch enable (ALE) pin, a write protect (WP) pin and a ready/busy output (R/B) pin.

The first I/O bus 206a and the second I/O bus 206b are used for respectively coordinating with the first control bus 204a and the second control bus 204b to execute commands and transmit the accessed data in accordance with the transmission protocol. The first I/O bus 206a is electrically connected between the first non-volatile memory chip 202a, the third non-volatile memory chip 202c, the fifth non-volatile memory chip 202e, the seventh non-volatile memory chip 202g and the controller 208. The second I/O bus 206b is electrically connected between the second non-volatile memory chip 202b, the fourth non-volatile memory chip 202d, the sixth non-volatile memory chip 202f, the eighth non-volatile memory chip 202h and the controller 208. In other words, when the controller 208 is desired to access the first non-volatile memory chip 202a, the third non-volatile memory chip 202c, the fifth non-volatile memory chip 202e and the seventh non-volatile memory chip 202g, the first I/O bus 206a is utilized to transmit the control command and the accessed data, and when the controller 208 is desired to access the second non-volatile memory chip 202b, the fourth non-volatile memory chip 202d, the sixth non-volatile memory chip 202f and the eighth non-volatile memory chip 202h, the second I/O bus 206b is utilized to transmit the control command and the accessed data.

The controller 208 is used for controlling a whole operation of the multi non-volatile memory chip packaged storage system 200, for example storage, read and erase, etc. of data. The controller 208 is electrically connected to the memory module. Especially, the controller 208 can transmits a chip enable signal via a first chip enable pin CE0 connected to the first non-volatile memory chip 202a and the second non-volatile memory chip 202b, a second chip enable pin CE1 connected to the third non-volatile memory chip 202c and the fourth non-volatile memory chip 202d, a third chip enable pin CE2 connected to the fifth non-volatile memory chip 202e and the sixth non-volatile memory chip 202f, and a fourth chip enable pin CE3 connected to the seventh non-volatile memory chip 202g and the eighth non-volatile memory chip 202h, so as to enable the first non-volatile memory chip 202a, the second non-volatile memory chip 202b, the third non-volatile memory chip 202c, the fourth non-volatile memory chip 202d, the fifth non-volatile memory chip 202e, the sixth non-volatile memory chip 202f, the seventh non-volatile memory chip 202g or the eighth non-volatile memory chip 202h.

To be specific, when the controller 208 is desired to access the first non-volatile memory chip 202a, the second non-volatile memory chip 202b, the third non-volatile memory chip 202c, the fourth non-volatile memory chip 202d, the fifth non-volatile memory chip 202e, the sixth non-volatile memory chip 202f, the seventh non-volatile memory chip 202g or the eighth non-volatile memory chip 202h, the controller 208 has to transmit the chip enable signal via the first chip enable pin CE0, the second chip enable pin CE1, the third chip enable pin CE2 or the fourth chip enable pin CE3 to enable the first non-volatile memory chip 202a, the second non-volatile memory chip 202b, the third non-volatile memory chip 202c, the fourth non-volatile memory chip 202d, the fifth non-volatile memory chip 202e, the sixth non-volatile memory chip 202f, the seventh non-volatile memory chip 202g or the eighth non-volatile memory chip 202h. Wherein, when the controller 208 transmits the chip enable signal via the first chip enable pin CE0, the first non-volatile memory chip 202a and the second non-volatile memory chip 202b can be simultaneously enabled, when the controller 208 transmits the chip enable signal via the second chip enable pin CE1, the third non-volatile memory chip 202c and the fourth non-volatile memory chip 202d can be simultaneously enabled, when the controller 208 transmits the chip enable signal via the third chip enable pin CE2, the fifth non-volatile memory chip 202e and the sixth non-volatile memory chip 202f can be simultaneously enabled, and when the controller 208 transmits the chip enable signal via the fourth chip enable pin CE3, the seventh non-volatile memory chip 202g and the eighth non-volatile memory chip 202h can be simultaneously enabled.

The controller 208 includes a memory interface 208-1 and a microprocessor 208-2. The memory interface 208-1 is used for accessing the memory module. Namely, data to be written into the memory module by the host is first transformed into a format that can be accepted by the memory module via the memory interface 208-1. The microprocessor 208-2 is electrically connected to the memory interface 208-1 for receiving and processing the commands executed by the host, for example, data writing, data reading and data erasing, etc.

It should be noted that since when the controller 208 transmits the chip enable signal, two non-volatile memory chips connected to a same chip enable pin can be simultaneously enable, the microprocessor 208-2 of the controller 208 may have different operations based on execution of a single channel access and a multi channel access, wherein the single channel access means that only one I/O bus is activated at a same time for accessing a single non-volatile memory chip, and the multi channel access means that a plurality of I/O buses are activated at the same time for accessing multiple non-volatile memory chips.

To be specific, when the microprocessor 208-2 is desired to perform a double channel write (or read) to the first non-volatile memory chip 202a and the second non-volatile memory chip 202b, the microprocessor 208-2 first transmits the chip enable signal via the first chip enable pin CE0 to enable the first non-volatile memory chip 202a and the second non-volatile memory chip 202b, and then simultaneously executes a write (or read) command to the first non-volatile memory chip 202a and the second non-volatile memory chip 202b respectively via the first control bus 204a and the first I/O bus 206a, and the second control bus 204b and the second I/O bus 206b. Then, the microprocessor 208-2 respectively transmits the accessed data of the first non-volatile memory chip 202a and the second non-volatile memory chip 202b via the first I/O bus 206a and the second I/O bus 206b. By such means, double channel access of the first non-volatile memory chip 202a and the second non-volatile memory chip 202b is achieved, and therefore the system performance is improved.

Moreover, when the microprocessor 208-2 is desired to perform a single channel write (or read) to the first non-volatile memory chip 202a, the microprocessor 208-2 first transmits the chip enable signal via the first chip enable pin CE0 to enable the first non-volatile memory chip 202a, and then only executes a write (or read) command to the first non-volatile memory chip 202a via the first control bus 204a and the first I/O bus 206a. Then, the microprocessor 208-2 transmits the accessed data of the first non-volatile memory chip 202a via the first I/O bus 206a. However, though the second non-volatile memory chip 202b is also enabled when the first non-volatile memory chip 202a is enabled, the microprocessor 208-2 does not activate the second control bus 204b, and therefore the second non-volatile memory chip 202b is not activated.

In addition, though not illustrated in the present embodiment, the controller 208 may further includes commonly used functional modules of a general flash memory controller such as a memory management module, a buffer memory and a power management module, etc.

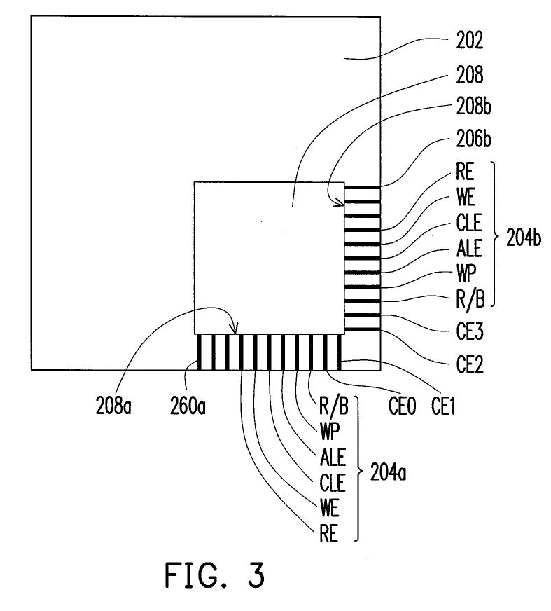

It should be noted that the multi non-volatile memory chip packaged storage system 200 is a system-on-chip packaged based on the MCP technique. As shown in FIG. 3, the controller 208 and the memory module are stacked and packaged as a single chip, wherein since a size of the controller 208 is less than that of the memory module having multiple memory chips, during a stacking, the first control bus and the first I/O bus, and the second control bus and the second I/O bus are respectively electrically connected out from two adjacent sides of the controller 208, i.e. are lined along L-type sides (for example, sides 208a and 208b of FIG. 3) of the controller 208. To be specific, the first control bus, the first I/O bus, the first chip enable pin CE0 and the second chip enable pin CE1 are electrically connected between the first non-volatile memory chip 202a, the third non-volatile memory chip 202c, the fifth non-volatile memory chip 202e, and the seventh non-volatile memory chip 202g of the controller 208 and the memory module at the side 208a, and the second control bus, the second I/O bus 206b, the third chip enable pin CE2 and the fourth chip enable pin CE3 are electrically connected between the second non-volatile memory chip 202b, the fourth non-volatile memory chip 202d, the sixth non-volatile memory chip 202f and the eighth non-volatile memory chip 202h of the controller 208 and the memory module at the side 208b.

In an embodiment of the present invention, the multi non-volatile memory chip packaged storage system 200 further includes a data transmission link interface for connecting the host (not shown), wherein the data transmission link interface can be an SD interface, a PCI express interface, an IEEE 1394 interface, a SATA interface, an MS interface, an MMC interface, a USB interface, a CF interface, an IDE interface or other suitable data transmission interfaces.

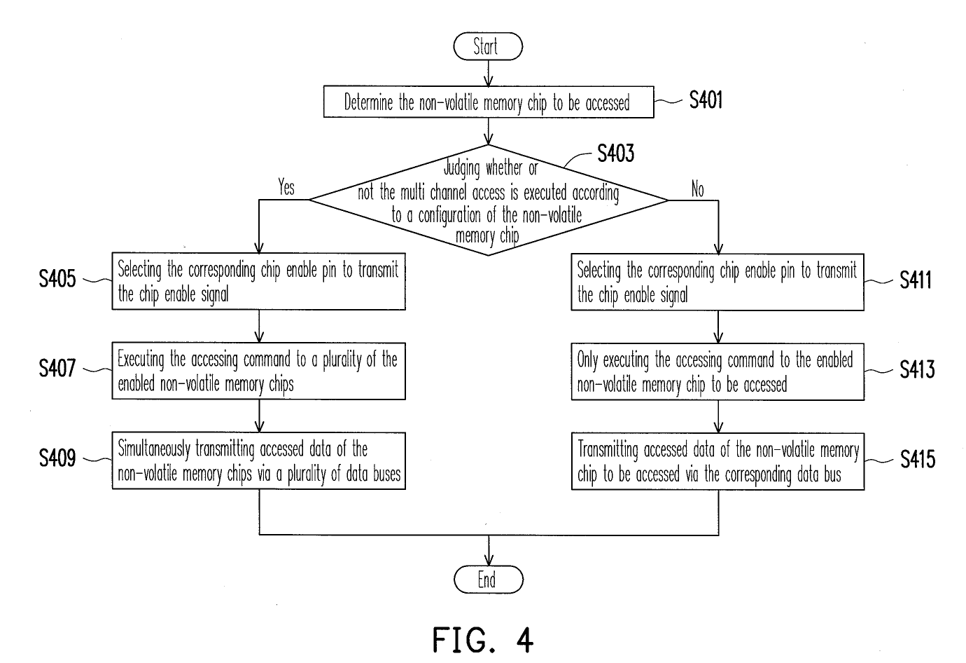

FIG. 4 is a flowchart illustrating a data access method according to an embodiment of the present invention.

Referring to FIG. 4, when the host is desired to access (i.e. write or read) the multi non-volatile memory chip packaged storage system 200, in step S401, the microprocessor 208-2 determines the non-volatile memory chips to be accessed. Next, in step S403, whether or not the multi channel access is executed is judged according to a configuration of the non-volatile memory chips.

If in the step S403, the multi channel access is judged to be executed (for example, the third non-volatile memory chip 202c and the fourth non-volatile memory chip 202d are simultaneously accessed), in step S405, the corresponding chip enable pin (for example, the chip enable pin CE1) is selected, and the chip enable signal is transmitted. Next, in step S407, the microprocessor 208-2 executes the accessing command to the enabled non-volatile memory chips (for example, the third non-volatile memory chip 202c and the fourth non-volatile memory chip 202d). Finally, in step S409, accessed data of the non-volatile memory chips are simultaneously transmitted via a plurality of the I/O buses, for example, the accessed data of the third non-volatile memory chip 202c is transmitted via the first I/O bus 206a, and the accessed data of the fourth non-volatile memory chip 202d is transmitted via the second I/O bus 206b.

If in the step S403, the single channel access is judged to be executed (for example, only the first non-volatile memory chip 202a is accessed via the single channel access), in step S411, the corresponding chip enable pin (for example, the chip enable pin CE0) is then selected, and the chip enable signal is transmitted. Next, in step S413, the microprocessor 208-2 only executes the accessing command to the enabled non-volatile memory chip to be accessed, for example, the microprocessor 208-2 executes the accessing command to the first non-volatile memory chip 202a via the first control bus 204a and the first I/O bus 206a. Moreover, the simultaneously enabled but not accessed non-volatile memory chip is not activated. Finally, in step S415, data of the non-volatile memory chip to be accessed is then transmitted via the corresponding I/O bus, for example, the accessed data of the first non-volatile memory chip 202a is transmitted via the first I/O bus 206a.

It should be noted that in the present embodiment, since the microprocessor 208-2 can access different non-volatile memory chips connected to the same chip enable pin respectively via independent control and I/O buses, according to the access method of the present invention, different blocks of different non-volatile memory chips can be accessed based on the multi channel access.

In summary, in the present invention, a single chip enable pin is applied to connect multiple non-volatile memory chips based on the MCP technique, so as to reduce a number of the chip enable pins and reduce the size of the non-volatile memory chip packaged storage system. Moreover, the microprocessor activates a plurality of the control and I/O buses to execute the same accessing command for accessing the simultaneously enabled non-volatile memory chips, so that the multi channel access of the multi non-volatile memory chip packaged storage system can be achieved. Moreover, the microprocessor can only activate one of the control and I/O buses to execute the accessing command for accessing a specific non-volatile memory chip, so that the single channel access can also be achieved under a structure that a single chip enable pin is connected to a plurality of the non-volatile memory chips.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multi non-volatile memory chip packaged storage system, comprising:
a memory module, having a first non-volatile memory chip and a second non-volatile memory chip, wherein the first non-volatile memory chip and the second non-volatile memory chip are both enabled by simultaneously receiving a chip enable signal via a first chip enable pin;
a controller, electrically connected to the memory module for outputting the chip enable signal, wherein the controller and the memory module are stacked and packaged as a chip based on a multi chip package technique;
a first I/O bus and a second I/O bus, respectively electrically connected between the first non-volatile memory chip and the controller, and between the second non-volatile memory chip and the controller; and
a first control bus and a second control bus, respectively electrically connected between the first non-volatile memory chip and the controller, and between the second non-volatile memory chip and the controller,
wherein when the controller executes a multi channel access, the controller executes an accessing command to the first non-volatile memory chip via the first control bus and the first I/O bus, and transmits accessed data via the first I/O bus, and meanwhile the controller executes the accessing command to the second non-volatile memory chip via the second control bus and the second I/O bus, and transmits accessed data via the second I/O bus after the controller enables the first non-volatile memory chip and the second non-volatile memory chip via the first chip enable pin,
wherein when the controller executes a single channel access to the first non-volatile memory chip, the controller only executes the accessing command to the first non-volatile memory chip via the first control bus and the first I/O bus, and transmits accessed data via the first I/O bus after the controller enables the first non-volatile memory chip and the second non-volatile memory chip via the first chip enable pin,
wherein when the controller executes the single channel access to the second non-volatile memory chip, the controller only executes the accessing command to the second non-volatile memory chip via the second control bus and the second I/O bus, and transmits accessed data via the second I/O bus after the controller enables the first non-volatile memory chip and the second non-volatile memory chip via the first chip enable pin.

2. The multi non-volatile memory chip packaged storage system as claimed in claim 1, wherein the first control bus and the first I/O bus, and the second control bus and the second I/O bus are respectively electrically connected to the first non-volatile memory chip and the second non-volatile memory chip from two adjacent sides of the controller.

3. The multi non-volatile memory chip packaged storage system as claimed in claim 1, wherein the accessing command is a write command or a read command.

4. The multi non-volatile memory chip packaged storage system as claimed in claim 1, wherein the memory module further comprises:
a third, a fifth and a seventh non-volatile memory chips, electrically connected to the first I/O bus and the first control bus; and
a fourth, a sixth and an eighth non-volatile memory chips, electrically connected to the second I/O bus and the second control bus,
wherein the controller enables the third and the fourth non-volatile memory chips via a second chip enable pin, enables the fifth and the sixth non-volatile memory chips via a third chip enable pin, and enables the seventh and the eighth non-volatile memory chips via a fourth chip enable pin.

5. The multi non-volatile memory chip packaged storage system as claimed in claim 1, wherein the first non-volatile memory chip and the second non-volatile memory chip are single level cell (SLC) NAND flash memories or multi level cell (MLC) NAND flash memories.

6. The multi non-volatile memory chip packaged storage system as claimed in claim 1, further comprises a data transmission link interface.

7. The multi non-volatile memory chip packaged storage system as claimed in claim 6, wherein the data transmission link interface is a PCI express interface, a USB interface, an IEEE1394 interface, a SATA interface, an MS interface, an MMC interface, an SD interface, a CF interface or an IDE interface.

8. A controller, adapted to control a memory module of a multi non-volatile memory chip packaged storage system, wherein the memory module comprises a first non-volatilememory chip and a second non-volatile memory chip, and the first non-volatile memory chip and the second non-volatile memory chip are both enabled by simultaneously receiving a chip enable signal via a first chip enable pin, the controller comprising:
a memory interface, for accessing the memory module; and
a microprocessor, electrically connected to the memory interface for outputting the chip enable signal,
wherein when the microprocessor executes a multi channel access, the microprocessor executes an accessing command to the first non-volatile memory chip via a first control bus and a first I/O bus of the multi non-volatile memory chip packaged storage system, and transmits accessed data via the first I/O bus of the multi non-volatile memory chip packaged storage system, and meanwhile the microprocessor executes the accessing command to the second non-volatile memory chip via a second control bus and a second I/O bus of the multi non-volatile memory chip packaged storage system, and transmits accessed data via the second I/O bus of the multi non-volatile memory chip packaged storage system after the microprocessor enables the first non-volatile memory chip and the second non-volatile memory chip via the first chip enable pin,
wherein when the microprocessor executes a single channel access to the first non-volatile memory chip, the microprocessor only executes the accessing command to the first non-volatile memory chip via the first control bus and the first I/O bus, and transmits accessed data via the first I/O bus after the microprocessor enables the first non-volatile memory chip and the second non-volatile memory chip via the first chip enable pin,
wherein when the microprocessor executes the single channel access to the second non-volatile memory chip, the microprocessor only executes the accessing command to the second non-volatile memory chip via the second control bus and the second I/O bus, and transmits accessed data via the second I/O bus after the microprocessor enables the first non-volatile memory chip and the second non-volatile memory chip via the first chip enable pin.

9. The controller as claimed in claim 8, wherein the accessing command is a write command or a read command.

10. The controller as claimed in claim 8, wherein the memory module further comprises:
a third, a fifth and a seventh non-volatile memory chips, electrically connected to the first I/O bus and the first control bus; and
a fourth, a sixth and an eighth non-volatile memory chips, electrically connected to the second I/O bus and the second control bus,
wherein the microprocessor enables the third and the fourth non-volatile memory chips via a second chip enable pin, enables the fifth and the sixth non-volatile memory chips via a third chip enable pin, and enables the seventh and the eighth non-volatile memory chips via a fourth chip enable pin.

11. The controller as claimed in claim 8, wherein the first non-volatile memory chip and the second non-volatile memory chip are SLC NAND flash memories or MLC NAND flash memories.

12. The controller as claimed in claim 8, wherein the multi non-volatile memory chip packaged storage system is a flash drive, a flash memory card or a solid state drive.

13. An access method, adapted to a memory module of a multi non-volatile memory chip packaged storage system, wherein the memory module comprises a first non-volatilememory chip and a second non-volatile memory chip, and the first non-volatile memory chip and the second non-volatile memory chip are both enabled by simultaneously receiving a chip enable signal via a first chip enable pin, the access method comprising:
judging whether the first non-volatile memory chip and the second non-volatile memory chip are simultaneously accessed or only the first non-volatile memory chip or the second non-volatile memory chip is accessed;
when it is judged that the first non-volatile memory chip and the second non-volatile memory chip are simultaneously accessed, enabling the first non-volatile memory chip and the second non-volatile memory chip by a chip enable signal, executing an accessing command to the first non-volatile memory chip via a first control bus and a first I/O bus of the multi non-volatile memory chip packaged storage system, executing the accessing command to the second non-volatile memory chip via a second control bus and a second I/O bus, and respectively transmitting accessed data of the first non-volatile memory chip and the second non-volatile memory chip via the first I/O bus and the second I/O bus of the multi non-volatile memory chip packaged storage system;
when it is judged that only the first non-volatile memory chip is accessed, enabling the first non-volatile memory chip and the second non-volatile memory chip by the chip enable signal, only executing the accessing command to the first non-volatile memory chip via the first control bus and the first I/O bus, and transmitting accessed data of the first non-volatile memory chip via the first I/O bus; and
when it is judged that only the second non-volatile memory chip is accessed, enabling the first non-volatile memory chip and the second non-volatile memory chip by the chip enable signal, only executing the accessing command to the second non-volatile memory chip via the second control bus and the second I/O bus, and transmitting accessed data of the second non-volatile memory chip via the second I/O bus.

14. The access method as claimed in claim 13, wherein the accessing command is a write command or a read command.
